(19) United States
(12) Patent Application Publication
(10) Pub. No.: US 2026/0198521 A1
(43) Pub. Date: Jul. 16, 2026

(54) NON-DAIRY FROZEN DESSERT COMPOSITION AND METHOD FOR MANUFACTURING OF THE COMPOSITION

(71) Applicant: Oatly AB, MALMÖ (SE)

(72) Inventors: Nellie OSSVALL, MALMÖ (SE); Stina BURRI, MALMÖ (SE); Zandra JUST, MALMÖ (SE); Ida ANDERSSON, MALMÖ (SE)

(21) Appl. No.: 19/135,332

(22) PCT Filed: Dec. 5, 2022
(86) PCT No.: PCT/EP2022/084462

§ 371 Date: Jun. 3, 2025

(51) Int. Cl. A23G 9/42; A23G 9/32; A23G 9/34; A23L 29/10

(52) U.S. Cl. CPC A23G 9/42; A23G 9/327; A23G 9/34; A23L 29/10

(57) ABSTRACT

A non-dairy frozen dessert composition includes an oat-derived material having dry matter in an amount of 1 to 7% by weight of the frozen dessert composition, vegetable fat in an amount of 1 to 5% by weight of the frozen dessert composition, sugars in an amount of 5 to 20% by weight of the frozen dessert composition, maltodextrin in an amount of 3 to 8% by weight of the frozen dessert composition, emulsifier and stabilizer blend, and water.

### FIELD OF THE INVENTION

The invention relates to a non-dairy frozen dessert composition, a method for producing a non-dairy frozen dessert from the composition, and a method for manufacturing of a non-dairy frozen dessert composition.

### TECHNICAL BACKGROUND

Frozen dessert may be used for describing products having a sweet taste and being intended to be served frozen. Examples of frozen desserts include soft serve and milkshake.

Soft serve is a term used to describe a soft type of ice cream, which contains mixed in air. The air content may have an effect on the taste or sensation of the finished product. Product with low quantities of air may be perceived and described as heavier or denser. Ice cream with higher air content may be perceived as, smoother, lighter in texture and whiter in colour.

Milkshake is a term used to describe a dairy ice-cream-containing drink, often containing mixed in air.

Soft serves as well as milkshakes are typically made from pre-mixed products using a special machine that provides freezing and aeration of the soft serve at the point of sale to consumers.

It is problematic but desirable to achieve stability of the pre-mix, for example concerning emulsion stability and shelf life.

Soft serves and milk shakes are traditionally made using a dairy base. A demand for dairy substitute products is currently increasing and has been increasing over several years, at least in part from a desire from consumers to exclude or reduce the amount of animal products, such as dairy products, from their diet.

There is a further demand and need for dairy substitute products taking sustainability into account as well as health aspects, fueled by an interest in sustainability, vegetarianism, veganism as well as for improved health. In particular there is a demand for vegetable based or vegan non-dairy products.

Known frozen dessert products, such as non-dairy soft serves and non-dairy milkshake analogues, often require a relatively high level of fat, which may be hardened fat, and relatively high level of sugar, to provide desirable organoleptic properties of the soft serve, such as properties which may be described as creaminess, taste and mouth feel. Such product compositions may be considered less desirable for health reasons. There is, thus, a desire but also a problem to provide non-dairy soft serve and milkshake analogue compositions that are low in fat and associated with desirable organoleptic properties. It is further problematic to achieve such compositions that are low in sugar.

It is problematic with soft serves, and in particular with non-dairy or vegan soft serves, to avoid undesirable crystal growth in the frozen product. It is yet further problematic to achieve desirable organoleptic or sensory properties of soft serves, in particular of non-dairy or vegan soft serves.

It is sometimes problematic with dairy replacement products, to substitute the dairy fat while at the same time maintaining organoleptic properties and meet a desire to use healthier and vegetable based ingredients, eg. vegetable fats.

There is, thus, a need for non-dairy frozen dessert composition with improved properties, such as organoleptic properties and/or based on ingredients taking sustainability and health aspects into account.

### SUMMARY

One object of the invention is to alleviate, at least in part, drawbacks and/or problems of prior art. One object of the invention is to provide a non-dairy frozen dessert composition that can maintain stable emulsion. Another object of the invention is to provide a frozen dessert composition that is low in fat and/or sugar. Yet another object is to provide a frozen dessert composition associated with desirable organoleptic properties.

According to a first aspect, there is provided a non-dairy frozen dessert composition, the composition comprising: an oat-derived material comprising dry matter in an amount of 1 to 7% by weight of the frozen dessert composition; vegetable fat present in an amount of 1 to 5% by weight of the frozen dessert composition; sugars present in an amount of 5 to 20% by weight of the frozen dessert composition; maltodextrin present in an amount of 3 to 8% by weight of the frozen dessert composition; emulsifier and stabilizer blend; and water.

A content of oat-derived material allows a source of desirable and vegetable nutrients to be included in the non-dairy frozen dessert, such as, for example beta-glucan. The oat-derived material further allows for oat protein and oat fat to be included, together with, for example, any carbohydrates. Content of the oat-derived material may further contribute to texture and flavour of the non-dairy frozen dessert.

The specific composition, with the above stipulated levels of oat-derived material, vegetable fat, sugars, maltodextrin, emulsifier and stabilizer blend and water results in a non-dairy frozen dessert with which may be described as having low sugar- and fat levels. Further, the specific composition unexpectedly allows provision of a vegetable based non-dairy frozen dessert, such as soft serve or milkshake analogue, associated with desirable emulsification properties and provides desirable organoleptic properties, while also providing stability of the composition over time, for example, in terms of a stable emulsion. With stable emulsion is intended an emulsion, of the frozen dessert composition, that stays emulsified over time. The frozen dessert composition may stay emulsified at least for one day, such as at least for several days, or at least for six months.

It is surprising and appreciated that the combination of the ingredients within their respective intervals together functions to provide the desirable properties of the frozen dessert composition.

The frozen dessert composition may be a soft serve composition, wherein the oat-derived material comprises dry matter in an amount of 2.5 to 5% by weight of the frozen dessert composition, and the water is present in an amount of 62 to 75% by weight of the frozen dessert composition.

Such levels of oat-derived material and water lends the soft serve suitable and desirable organoleptic properties. For example, a creaminess suitable for soft serves may be achieved.

The frozen dessert composition may be a milkshake analogue composition, wherein, the oat-derived material comprises dry matter in an amount of 1.5 to 3.5% by weight of the frozen dessert composition, and the water is present in an amount of 68 to 80% by weight of the frozen dessert composition.

Such levels of oat-derived material and water lends the shake analogue suitable and desirable organoleptic properties. For example, a creaminess suitable for milkshake analogues may be achieved.

The sugars may comprise one or more of sucrose, dextrose, sugars from dried glucose and sugars from glucose syrup. Such sugars and blends of sugars, at the specified level of sugars, have shown to provide pleasant taste of the frozen dessert as well as having an effect on freezing point depression and may have an effect on ice crystallisation and thereby perceived texture and mouthfeel of the frozen dessert.

It shall further be noted that the sugars and blends of sugars functions well in combination with any carbohydrates, such as sugar, provided by the oat-derived material.

The emulsifier and stabiliser blend may comprise one or more compounds selected from the group consisting of comprising mono- and di-glycerides of fatty acids, guar gum, and gellan gum, in a total amount of 0.25-2% by weight of the frozen dessert composition.

The vegetable fat may comprise coconut fat. The coconut fat may be non-hydrogenated. The non-hydrogenated coconut fat may be coconut oil.

Such specific choice of fat for the frozen dessert composition in combination with the other ingredients of the composition, lends the frozen dessert a desirable creaminess, mouthfeel, richness, and taste. At the same time, the level of fat can be kept low, such as, for example, around and between 1-5% by weight of the composition.

The oat-derived material may have been obtained from treatment of oats comprising degradation of starch.

Such oat-derived material allows provision of improved flavour and mouthfeel, including improved richness and flavour, and reduced grittiness.

The oat-derived material may be a liquid oat base or an oat drink, or a combination thereof.

The oat-derived material may be a deamidated oat-derived material.

Such a deamidated oat derived material, may be an oat-derived material wherein oat proteins have been subjected to deamidation and thereby converted to more water soluble proteins.

It has unexpectedly been found that presence of deamidated oat proteins in the frozen dessert composition may improve organoleptic properties and improve stability of emulsion of the frozen dessert composition.

The oat-derived material may comprise one or more of monosaccharides, disaccharides, for example, maltose, oligosaccharides, and fibers, including β-glucan, the oat derived material may further comprise oat protein and oat fat.

Such an oat-derived material allows adding complexity to the frozen dessert. Further, nutritional benefits may be added, for example by inclusion of β-glucan.

The oat-derived material may be, for example, a liquid oat base or drink. The oat-derived material, or liquid oat base or oat drink, may comprise, by dry weight, 5-20% protein, and 3-15% fat, and optionally 10-80% carbohydrates, including sugars.

For the non-dairy frozen dessert composition being a soft serve, the oat-derived material may comprises dry matter in an amount of 2.5 to 4.5% by weight of the frozen dessert composition; the vegetable fat may be present in an amount of 2 to 4% by weight of the frozen dessert composition; the sugars may be present in an amount of 11 to 16% by weight of the frozen dessert composition, and comprises sucrose, and sugar from one or both of glucose syrup or dried glucose, and one or more of dextrose and fructose; the maltodextrin may be present in an amount of 5 to 8% by weight of the frozen dessert composition; the emulsifier and stabiliser blend may be present in an amount of 0.25 to 1.25% by weight of the frozen dessert composition; and the water may be present in an amount of 65 to 73% by weight of the frozen dessert composition.

For the frozen dessert composition being a soft serve composition, the oat-derived material may comprise dry matter in an amount of 3-4% by weight of the frozen dessert composition; the vegetable fat may be present in an amount of 3-4% by weight of the frozen dessert composition; the sugars may be present in an amount of 12.7-13.7% by weight of the frozen dessert composition; the maltodextrin may be present in an amount of 3 to 8% by weight of the frozen dessert composition; the emulsifier and stabiliser blend may be present in an amount of 0.5 to 1% by weight of the frozen dessert composition; and the water may be present in an amount of 67-70% by weight of the frozen dessert composition.

The maltodextrin present in an amount of 3 to 8%, may be, 3 to 5% or 5.5 to 7.5%.

Optionally, the emulsifier and stabiliser blend may in addition comprise 0.5-2% starch.

For the non-dairy frozen dessert composition being a milkshake analogue, the oat-derived material may comprise dry matter in an amount of 1.5 to 3.5% by weight of the frozen dessert composition; the vegetable fat may be present in an amount of 1 to 3% by weight of the frozen dessert composition; the sugars may be present in an amount of 11 to 15 by weight of the frozen dessert composition, and comprises sucrose and sugar from one or both of glucose syrup or dried glucose, and one or more of dextrose and fructose; the maltodextrin may be present in an amount of 4 to 9% by weight of the frozen dessert composition; the emulsifier and stabiliser blend may be present in an amount of 0.25 to 1.25% by weight of the frozen dessert composition; and the water may be present in an amount of 69 to 78% by weight of the frozen dessert composition.

For the non-dairy frozen dessert composition being a milkshake analogue, the oat-derived material may comprise dry matter in an amount of 2.3-3.3% by weight of the frozen dessert composition; the vegetable fat may be present in an amount of 1.5 to 2.5% by weight of the frozen dessert composition; the sugars may be present in an amount of 12 to 14% by weight of the frozen dessert composition, and comprises sucrose and sugar from one or both of glucose syrup or dried glucose, and one or more of dextrose and fructose; the maltodextrin may be present in an amount of 6 to 8% by weight of the frozen dessert composition; the emulsifier and stabiliser blend may be present in an amount of 0.25 to 1.25% by weight of the frozen dessert composition; and the water may be present in an amount of 71 to 75% by weight of the frozen dessert composition.

According to a second aspect, there is provided a non-dairy frozen dessert composition, the composition comprising: an oat-derived material comprising dry matter in an amount of 6 to 16% by dry weight of the composition; vegetable fat present in an amount of 5-15% by dry weight of the composition; sugars present in an amount of 25-45% by dry weight of the composition; maltodextrin present in an amount of 5 to 25% by dry weight of the composition; and emulsifier and stabiliser blend.

According to a third aspect, there is provided a method for producing a non-dairy frozen dessert from the non-dairy frozen dessert composition according to any one of the first aspect and the second aspect. The method comprises: providing the non-dairy frozen dessert composition according to any one of the first aspect or the second aspect; mixing in air; and freezing of the non-dairy frozen dessert composition. Thereby, the non-dairy frozen dessert may be obtained.

The method for producing a non-dairy frozen dessert from the non-dairy frozen dessert composition may be performed using a soft serve apparatus.

Thereby, a frozen dessert with overrun may efficiently be made. Further, soft serve apparatuses or machines are readily available in shops, restaurants etc. A soft serve apparatus may be used for preparing soft serves. The milkshake analogue may be prepared using a therefore dedicated apparatus, such as a milkshake machine.

According to a fourth aspect, there is provided a method for manufacturing of a non-dairy frozen dessert composition according to any one of the first aspect and the second aspect. The method comprises: providing a base composition comprising: an oat-derived material, vegetable fat, sugars, maltodextrin, emulsifier and stabiliser blend, and water; subjecting the base composition to heat treatment at a temperature above 125° C. followed by cooling to a temperature below 85° C.; subjecting the base composition to homogenisation followed by cooling below 30° C., thereby obtaining the non-dairy frozen dessert composition.

The heat treatment at a temperature above 125° C. provides, for example, UHT, thereby allowing improved shelf-life. The heat treatment further improves properties of the base composition, such as improved absorbance of water of components of the base composition. The cooling to a temperature below 85° C., which lends the heat treated base composition a temperature suitable for further processing and minimizes risks which may be associated with prolonged heat treatment, such as negative effects on taste or nutritional values.

The vegetable fat may be subjected to melting by heating prior to being provided for the base composition.

Thereby, the vegetable fat may more efficiently be mixed in with other ingredients of the base composition. Further, solid, or semi-solid fats may be used with the method.

The method may further comprise: mixing the base composition, following the providing the base composition, and preceding the subjecting the composition to heat treatment.

The mixing the base composition may initiate emulsification and/or homogenistation of the base composition. Further, components of the base composition, such as any proteins present, such as oat proteins from the oat derived material, may be allowed to hydrate, thus may provide improved emulsification and homogenisation.

According to a fifth aspect there is provided a non-dairy frozen dessert comprising the composition according to any one of the first aspect and the second aspect.

Such a non-dairy frozen dessert, such as, for example, a soft serve or a milkshake analogue, may be provided or served to a consumer. The non-dairy frozen dessert may be served, for example, in an ice-cream cone, or a beaker, in a glass, or on a plate, either alone or in combination with, for example, other type of frozen dessert, such as ice-cream, or other confectionary items.

The above-mentioned features of the one aspect, when applicable, apply to any of the other aspects as well. In order to avoid undue repetition, reference between aspects are hereby made.

### BRIEF DESCRIPTION OF THE DRAWINGS

Aspects of the present disclosure will now be described in more detail, with reference to the appended drawings.

FIG. 1 schematically illustrates a method for producing of a non-dairy frozen dessert.

FIG. 2 schematically illustrates a method for manufacturing a non-dairy frozen dessert composition.

### DETAILED DESCRIPTION OF THE INVENTION

The present invention will now be described more fully hereinafter. This invention may, however, be embodied in many different forms and should not be construed as limited to the embodiments set forth herein; rather, these embodiments are provided for thoroughness and completeness, and fully convey the scope of the invention to the skilled person. Although individual features may be included in different embodiments, these may possibly be combined in other ways, and the inclusion in different embodiments does not imply that a combination of features is not feasible. In addition, singular references do not exclude a plurality. In the context of the present invention, the terms “a”, “an” does not preclude a plurality.

The present inventive concepts are, at least in part, based on unexpected realizations including that a non-dairy frozen dessert composition, as defined by the appended claims and examples and embodiments described herein, i.e. a non-dairy frozen dessert composition, comprising an oat-derived material, vegetable fat, sugars, maltodextrin, emulsifier and stabiliser blend, and water may be provided having beneficial or desirable properties.

The present inventors have, after extensive research and development, found that a presence of an oat-derived material in the composition, with resulting benefits, have been made possible together with the other ingredients of the frozen dessert composition. Thus, frozen dessert compositions according to the present inventive concept, are achievable with desirable texture, organoleptic properties and emulsion stability, without hydrogenated fat and without further addition of protein. It has further been made possible to combine oat-derived material and other ingredients, which together form a desirable non-dairy frozen dessert composition, which composition further may be selected to be environmentally sustainable. Yet further and unexpectedly, the frozen dessert composition allows frozen desserts to be provided having relatively low levels of sugar and fat present, while maintaining desirable organoleptic properties, including taste, creaminess and richness of flavour.

The non-dairy frozen dessert may be a soft serve or a milkshake analogue. The soft serve and the milkshake analogue may be manufactured using recipes having similar ingredients, for example they may only differ in water content. The term frozen dessert composition as used herein is a composition which may be used for soft serve as well as milkshake analogues.

The non-dairy frozen dessert composition shall be understood as a composition suitable for or intended for making of soft serve and/or milkshake analogue. As such the composition may be, for example, a pre-mix for use with a soft serve machine. The term milkshake analogue may be used to describe a non-dairy product usable as analogue for and resembling a dairy milkshake. The frozen dessert, thus, may be a non-dairy soft serve or a non-dairy milkshake analogue.

Non-dairy, as used herein, is intended to describe a composition essentially free from dairy components. In addition to being described as a non-dairy frozen dessert composition, the composition may be described as a plant-based, a vegetable, a vegan, and/or a vegetarian non-dairy frozen dessert composition. The non-dairy frozen dessert composition may be totally free from animal ingredients. However, the non-dairy frozen dessert composition may contain additives derived from animal sources, and still be according to embodiments described herein.

Sugars, as used herein, may be mono- or di-sugars. Thus, for example if tri-sugars are included in the composition, it may not be included in the sugars.

The frozen dessert compositions described herein, may be used as such for making of frozen desserts, for example using a suitable soft serve machine, without further additions. Thus, it shall be noted that the frozen dessert composition as discussed herein may also be describing the frozen dessert as such made therefrom, in terms of ingredients and levels of ingredients. The frozen dessert may, thus, be described as the frozen dessert composition in a frozen, and aerated, or having over-run, state.

According to the first aspect, there is provided a non-dairy frozen dessert composition, the composition comprising: an oat-derived material comprising dry matter in an amount of 1 to 7% by weight of the frozen dessert composition; vegetable fat present in an amount of 1 to 5% by weight of the frozen dessert composition; sugars present in an amount of 5 to 20% by weight of the frozen dessert composition; maltodextrin present in an amount of 3 to 8% by weight of the frozen dessert composition; emulsifier and stabilizer blend; and water.

It was found by the inventors, that it was possible to have a content of oat-derived material comprising desirable and vegetable nutrients to be included in the frozen dessert, such as, for example beta-glucan, while at the same time achieving a stable emulsion. In particular, oat-derived material comprising oat protein and oat fat may be included, together with carbohydrates of the oat-derived material.

The specific composition, with the above stipulated levels of oat-derived material, vegetable fat, sugars, maltodextrin, emulsifier and stabilizer blend and water unexpectedly allow provision of vegetable based frozen desserts in form of soft serves and milkshake analogues associated with desirable emulsification properties and providing desirable organoleptic properties, while also providing stability of the composition over time, for example, in terms of a stable emulsion. It is surprising and appreciated that the combination of the ingredients within their respective intervals together functions to provide the desirable properties of the frozen dessert composition.

The vegetable fat and the sugars are in addition to any vegetable fat and sugars comprised by the oat-derived material. Thus, and for example, if the oat-derived material comprises oat fat, that oat fat is not included in the vegetable fat. Any water included in the oat-derived material shall, however, be calculated, viewed and/or treated as a portion of or part of the water, as further discussed and explained herein below.

The frozen dessert may be a soft serve or a milkshake analogue. Thus, soft serves as well as milkshake analogues may be made from the composition of the first aspect.

The non-dairy frozen dessert composition may be a non-dairy soft serve composition and/or a non-dairy milkshake analogue composition.

The frozen dessert composition may be a soft serve composition, wherein the oat-derived material comprises dry matter in an amount of 2.5 to 5% by weight of the frozen dessert composition, and the water is present in an amount of 62 to 75% by weight of the frozen dessert composition.

Such levels of oat-derived material and water lends the soft serve suitable and desirable organoleptic properties. For example, a creaminess suitable for soft serves may be achieved. Yet further, an over-run suitable for soft serves was achievable.

The frozen dessert composition may be a milkshake analogue composition, wherein, the oat-derived material comprises dry matter in an amount of 1.5 to 3.5% by weight of the frozen dessert composition, and the water is present in an amount of 68 to 80% by weight of the frozen dessert composition.

Such levels of oat-derived material and water lends the shake analogue suitable and desirable organoleptic properties. For example, a creaminess suitable for milkshake analogues may be achieved.

It was found that lower levels of oat-derived material and higher levels of water may be used for milkshake analogues as compared to soft serves. It is an unexpected advantage that milkshake analogues and soft serves may be made from identical ingredients, but suitably the respective compositions differ in water content, wherein the milkshake analogue has a higher content of water. Thus, a composition, such as a pre-mix may be provided that is suitable for and can be used both for soft serves and milkshake analogues by adding different amount of water during preparation of the composition or during preparation of the frozen dessert.

The soft serve composition may have a content of dry matter of 25 to 35%, for example 28 to 33%.

The milkshake analogue may have a content of dry matter of 20 to 30%, for example 22 to 26%.

It shall be realised that with the compositions a higher level of dry matter is associated with lower level of water, or aqueous liquid. Thus, it has been found that a soft serve, as compared to a milkshake analogue, may suitably be made with higher levels of dry matter (including, for example, fat, sugars, maltodextrin) and lower level of water. It was found that such a composition provides a richness in taste, and increased creaminess or viscosity for soft serves. On the other hand, a higher level of water and lower level of dry matter may result in a high over-run in combination with suitable richness and creaminess for milkshake analogues.

The sugars may comprise one or more of sucrose, dextrose, sugars from dried glucose and sugars from glucose syrup, and, optionally, fructose.

A combination of such sugars with the oat-derived material in form of an oat base or an oat drink provides a desirable product.

The glucose syrup may be, for example, a solution or liquid of saccharides obtained by hydrolysis of starch, such as wheat starch or corn starch, characterised by a high polysaccharide content. The glycose syrup may, for example, have a dry content of 70-90% by weight, such as 75-85% by weight, or 79-81% by weight of carbohydrates. Of the glucose syrup, for example 20-50% by weight may be sugars. Of the sugars present in an amount of 5 to 20% by weight of the frozen dessert composition, 1-3%, or 1-2%, by weight of the frozen dessert composition, may be sugars from glucose syrup.

As an alternative to glucose syrup in solution, dry glucose may be used, or a glucose syrup in dry form or essentially without water.

A combination of glucose syrup and dried glucose may also be used.

According to one example, the glucose syrup may have a content of dry matter which comprises dextrose, maltose, maltotriose, and higher sugars, for example at levels of 15-19%, 11-15%, 11-15%, and 55-60%, respectively, by weight of the dry matter.

According to an example, the dried glucose may be a dried glucose syrup obtained by hydrolysis of starch. Based on dry matter, the dried glucose syrup may comprise 2-4%, or about 3% of dextrose, 10-14%, or about 12% of maltose, in addition the dried glucose may comprise 12-16%, or about 14% of maltotriose, and 69-73%, or about 71% of higher sugars. Thus, the sugar content of the dried glucose, or dried glucose syrup, by weight of dry matter, including mono- and di-saccharides, may be about 10-20%, or 12-18%, or about 15%. The water content of the dried glucose syrup may be 5% or below by weight of the dried glucose syrup, or 0-5% by weight.

The non-dairy frozen dessert composition may further comprise a buffering agent.

The buffering agent may be selected from suitable food acidity regulators.

The non-dairy frozen dessert composition may further comprise other ingredients and additives, for example, the composition may comprise one or more of salt, coloring agents, flavorings, vitamins etc. Flavorings may be selected from the list consisting of vanilla, chocolate (cocoa), caramel, strawberry, raspberry, blueberry, and combinations thereof. The flavourings may be present in the composition in amounts up to 1%, or up to 0.5%, by weight of the composition.

The salt (NaCl) may be plain table salt or sea salt. The amount of salt may be 0.05% to 1%, such as 0.06 to 0.5% by weight of the composition.

The emulsifier and stabiliser blend may comprise one or more compounds selected from the group consisting of comprising mono- and di-glycerides of fatty acids, guar gum, and gellan gum, in a total amount of 0.25-2% by weight of the frozen dessert composition.

In addition, the emulsifier and stabilizer blend may comprise additives or agents, such as, for example, help agents or filling agents. Such additives or agents may be inert in the sense that they essentially do not contribute to flavour or emulsification or stabilizing properties of the frozen dessert, but they may have other processing benefits, for example in improving handling of the blend, for example improved flowability. Alternatively, the additive or agent may have a contribution, for example in terms of having an effect on viscosity of the composition. In addition to the mono- and di-glycerides of fatty acids, guar gum, and gellan gum, in a total amount of 0.25-2% by weight of the frozen dessert composition, the group of the emulsifier and stabiliser blend may comprise starch, such as corn starch. The starch may be present up to 2%, such as 0.5-2%, or 0.5-1.5%, or about 1%, by weight of the frozen dessert composition. The total amount of the group consisting of mono- and di-glycerides of fatty acids, guar gum, gellan gum, and starch may be 0.75-3.5% by weight of the frozen dessert composition, within which range the level of the group consisting of mono- and di-glycerides of fatty acids, guar gum, gellan gum may be according to the above specified 0.25-2%, and the level of starch may be according to the above specified 0.5-1.5%.

The emulsifier and stabiliser blend may be present in an amount of 0.25-1.25, or 0.5-1%, by weight of the frozen dessert composition. The emulsifier and stabiliser blend may be present in an amount of 0.25-1.25, or 0.5-1%, by weight of the frozen dessert composition, wherein the emulsifier and stabiliser blend contains at least 90% by weight, or 95-100% by weight, or 100% by weight, of one or more, or all of: mono- and di-glycerides of fatty acids, guar gum, and gellan gum.

The levels of the emulsifier and stabilizer blend, in combination with the specific compounds of the of emulsifier and stabilizer blend lend the frozen dessert composition specifically well suited properties, including, for example, creaminess to the frozen dessert and allows buildup of a stable suspension or emulsion of fat in water.

The overall ingredients of the non-dairy frozen dessert composition, for example including the emulsifier and stabilizer blend, relatively low levels of sugar and fat, oat-derived material, and maltodextrin together appear to function to provide suitable properties, including organoleptic properties, to the frozen dessert composition.

The vegetable fat may comprise coconut fat. The coconut fat may be non-hydrogenated. The non-hydrogenated coconut fat may be referred to as coconut oil.

Other vegetable fats may be used in combination with coconut fat, or instead of coconut fat.

In addition to the vegetable fat, the frozen dessert composition may comprise vegetable fat from the oat-derived material.

The water may be present in an amount of 55 to 90% by weight of the composition. Such water levels allow soft serve as well as milkshake analogue to be manufactured. The water may be present in an amount of 60-85%, for example 65-80% by weight of the composition, which levels also allow soft serve as well as milkshake analogue to be manufactured.

The water may be present in an amount of 62 to 75%, or 65 to 73%, such as 67 to 70%, by weight of the composition, suitable for soft serves.

The water may be present in an amount of 68 to 80%, or 69 to 78%, such as 71 to 75%, by weight of the composition, suitable for milkshake analogues. The water is the total water of the composition, i.e. any water present in the composition which may have been added as free water and/or any water present in or provided with other ingredients of the frozen dessert composition. In particular the oat-derived material may be provided as aqueous liquid, such as, for example, in form of a liquid oat base or an oat drink, sometimes referred to as an oat milk, in which case the water provided with the oat-derived material is included in the amount of water, for example the 60 to 85% by weight of the composition. As a further example, all water of the frozen dessert composition may be added or provided with the oat derived material, for example if the oat derived material is provided as a relatively water diluted suspension of oat-derived material. As yet a further example, the oat-derived material may be provided as a dry powder or formulation, for which case essentially all or all water present in the frozen dessert composition may be provided as free water added to the frozen dessert composition.

The oat-derived material may have been obtained from treatment of oats comprising degradation of starch.

For example, starch of the oats may be subjected to enzymatic hydrolysis, such as hydrolysis by amylase. The amylase may be one or more of α-amylase and β-amylase. During the hydrolysis, or degradation of starch, starch of the oats may be converted to lower types of starch, including sugars, such as, for example, maltose.

As such, the oat-derived material may be a liquid, aqueous, oat base or an oat drink, or a combination thereof. The oat derived material may also be such an oat base in dried form.

Such an oat-derived material, or a liquid oat base or an oat drink, may be obtained from degradation of starch of oats.

The oat base or oat drink may comprise, by dry weight of the oat base or oat drink, 5-20% protein, and 3-15% fat, and optionally 10-80% carbohydrates, including sugars.

Typically, the liquid oat base or oat drink may comprise sugars 2-8%, fibres 0.2-3% (out of which 0.1-1% of the oat base or oat drink is beta glucans), fat 0.0-2.5%, and proteins 0.5-2.5%, by weight of the oat base or drink. The dry matter of the liquid oat base may be, for example, 10-20%, eg. 12-14%, or 13% or 14%, by weight of the liquid oat base or oat drink.

The liquid oat base or oat drink may comprise the following, expressed in % by weight of the liquid oat base: sugars 4-6%, or eg. 5%; beta glucans 0.25-0.75%, or eg. 0.5%; fat 0.5-1%, or eg. 0.8%; and proteins 1-2%, or eg. 1.5%, wherein the dry matter of the liquid oat base or oat drink may be 12-14% by weight. Carbohydrates, including the sugars, may be present at 7-10.5%, or eg. 9.5%. Such an oat base may comprise, by dry weight of the oat base or oat drink, sugars 30-40%, or eg. 35%; beta glucans 2-6%, or eg. 4%; fat 4-8%, or eg. 6%; and proteins 9-13%, or eg. 11%. Carbohydrates, including the sugars, may be present at 65-80%, or eg. 73%.

The oat-derived material may be a liquid oat base or oat drink obtained from treatment of oats comprising treatment with amylase.

It has been surprisingly found that the liquid oat base as described herein above, which may be viewed as having a complex composition of several compounds, provides improved organoleptic properties to the frozen dessert, and that it can be used with the other ingredients and still form a stable suspension.

The oat-derived material may be a deamidated oat-derived material.

Such a deamidated oat derived material, may be an oat-derived material wherein oat proteins have been subjected to deamidation and thereby converted to more water soluble proteins, for example using protein deamidase, or protein glutaminase.

It has unexpectedly been found that presence of deamidated oat proteins in the frozen dessert composition may further improve organoleptic properties and improve stability of emulsion of the frozen dessert composition. A deamidated oat-derived material has higher levels of water soluble proteins, which is believed to have an effect on improved emulsion stability.

The deamidated oat-derived material may have been subjected to treatment with protein deamidase, for example protein glutaminase.

For the non-dairy frozen dessert composition being a soft serve composition, the oat-derived material may comprises dry matter in an amount of 2.5 to 4.5% by weight of the frozen dessert composition; the vegetable fat may be present in an amount of 2 to 4% by weight of the frozen dessert composition; the sugars may be present in an amount of 11 to 16% by weight of the frozen dessert composition, and comprises sucrose, and sugar from one or both of glucose syrup or dried glucose, and one or more of dextrose and fructose; the maltodextrin may be present in an amount of 5 to 8% by weight of the frozen dessert composition; the emulsifier and stabiliser blend may be present in an amount of 0.25 to 1.25% by weight of the frozen dessert composition; and the water may be present in an amount of 65 to 73% by weight of the frozen dessert composition. Optionally, the emulsifier and stabiliser blend may in addition comprise 0.5-2% starch. Suitably, the oat-derived material may be a liquid oat-base or oat drink.

The maltodextrin present in an amount of 3 to 8% may be within the range 3 to 5% or within the range 5.5 to 7.5%.

For the frozen dessert composition being a soft serve composition, the oat-derived material may comprise dry matter in an amount of 3-4% by weight of the frozen dessert composition; the vegetable fat may be present in an amount of 3-4% by weight of the frozen dessert composition; the sugars may be present in an amount of 13-14% by weight of the frozen dessert composition; the maltodextrin may be present in an amount of 3 to 8% by weight of the frozen dessert composition; the emulsifier and stabiliser blend may present in an amount of 0.5 to 1% by weight of the frozen dessert composition; and the water may be present in an amount of 67-70% by weight of the frozen dessert composition.

For the soft serve, the sugars may comprise sucrose and sugar from glucose syrup, dextrose, and fructose.

For the non-dairy frozen dessert composition being a milkshake analogue, the oat-derived material may comprise dry matter in an amount of 1.5 to 3.5% by weight of the frozen dessert composition; the vegetable fat may be present in an amount of 1 to 3% by weight of the frozen dessert composition; the sugars may be present in an amount of 11 to 15% by weight of the frozen dessert composition, and comprises sucrose and sugar from one or both of glucose syrup or dried glucose, and one or more of dextrose and fructose; the maltodextrin may be present in an amount of 4 to 9% by weight of the frozen dessert composition; the emulsifier and stabiliser blend may be present in an amount of 0.25 to 1.25% by weight of the frozen dessert composition; and the water may be present in an amount of 69 to 78% by weight of the frozen dessert composition.

For the non-dairy frozen dessert composition being a milkshake analogue, the oat-derived material may comprise dry matter in an amount of 2.3 to 3.3% by weight of the frozen dessert composition; the vegetable fat may be present in an amount of 1.5 to 2.5% by weight of the frozen dessert composition; the sugars may be present in an amount of 12 to 14% by weight of the frozen dessert composition, and comprises sucrose and sugar from glucose syrup or dried glucose, dextrose, and, optionally, fructose; the maltodextrin may be present in an amount of 4 to 6% by weight of the frozen dessert composition; the emulsifier and stabiliser blend is present in an amount of 0.25 to 1.25% by weight of the frozen dessert composition; and the water may be present in an amount of 71 to 75% by weight of the frozen dessert composition.

For the milkshake analogue, the sugars may comprise sucrose and sugar from glucose syrup, dextrose, and fructose

The total content of protein in the non-dairy frozen dessert composition may be 2% or below, by weight of the non-dairy frozen dessert composition, such as 0.1-2%, 0.1-1.5%, or 0.1-1%, which may include any protein from the oat-derived material.

The total content of protein in the non-dairy frozen dessert composition may be from any protein present with the oat-derived material, which may be within the interval 0.1-2% by weight of the non-dairy frozen dessert composition.

According to the second aspect, there is provided a non-dairy frozen dessert composition, the composition comprising: an oat-derived material comprising dry matter in an amount of 6 to 16% by dry weight of the composition; vegetable fat present in an amount of 5-15% by dry weight of the composition; sugars present in an amount of 25-45% by dry weight of the composition; maltodextrin present in an amount of 5 to 25% by dry weight of the composition; and emulsifier and stabiliser blend.

Such a composition may be used for both the soft serves and the milkshake analogues. The difference may be, at least in part, the level of water.

The non-dairy frozen dessert composition according to the second aspect may further comprise water.

It shall be realised that variants of the second aspect may correspond to variants of the first aspect. Components of the second aspect is however expressed in terms of percent by dry weight of the composition, while components of the first aspect is expressed in terms of percent by weight of the composition. The composition according to the first aspect having a content of water may therefore result in difference between levels of components (expressed in percent by weight of the composition), as compared to components of the second aspect (expressed in percent by dry weight of the composition).

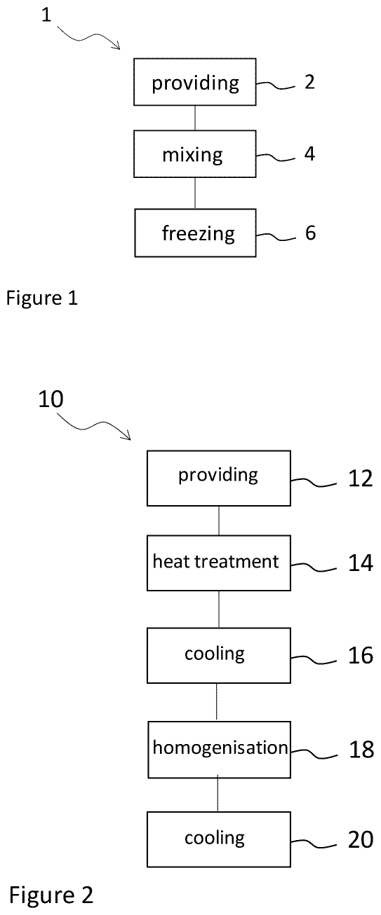

With reference to FIG. 1, a method for producing a non-dairy frozen dessert from the non-dairy frozen dessert composition according to the first aspect or the second aspect is illustrated. The method 1 comprises: providing 2 the non-dairy frozen dessert composition according to any one of the first aspect or the second aspect; mixing 4 in air; and freezing 6 of the non-dairy frozen dessert composition. Thereby, the non-dairy frozen dessert, such as a soft serve or milkshake analogue, may be obtained.

The mixing 4 in air provides the frozen dessert with an overrun. The overrun may be 30% or above, such as 45 to 100%. With the present compositions, for a soft serve, an overrun of 45-90%, for example 50-80% is achievable and suitable. With the present compositions, for a milkshake analogue, an overrun of 50-100%, for example 60-90% is achievable and suitable. The overrun may be selected to suit an end-user or consumer of the frozen dessert, and also selected to suit the type of frozen dessert. For example, the over-run, or mixing 4 in air, may be selected higher for a soft serve as compared to for a milkshake analogue.

The mixing 4 in air and the freezing 6 may be conducted, at least in part, simultaneously.

It shall be appreciated that the frozen dessert composition according to the first aspect or the second aspect may be manufactured with a water content suitable for producing a non-dairy soft serve and/or a milkshake analogue. However, if, for any reason, it is deemed suitable to mix in additional water during the producing of a non-dairy frozen dessert, it shall be an option.

Thus, the method may further comprise adding water or aqueous liquid,

The adding water or aqueous liquid may be conducted before the mixing in air; and the freezing of the non-dairy frozen dessert composition.

Thereby, a non-dairy frozen dessert composition having a lower level of water than desirable for the frozen dessert may be used as starting material. This may allow, for example, improved stability and shelf-life of the composition, and more efficient transportation and storage of the composition prior to use.

With reference to FIG. 2, a method 10 for manufacturing of a non-dairy frozen dessert composition according to any one of the first aspect and the second aspect is illustrated. The method 10 comprises: providing 12 a base composition comprising: an oat-derived material, vegetable fat, sugars, maltodextrin, emulsifier and stabiliser blend, and water; subjecting the base composition to heat treatment 14 at a temperature above 125° C. followed by cooling 16 to a temperature below 85° C.; subjecting the base composition to homogenization 18 followed by cooling 20 below 30° C., thereby obtaining the non-dairy frozen dessert composition.

The heat treatment 14 at a temperature above 125° C. may provide, for example, UHT, thereby allowing improved shelf-life. The heat treatment 14 further may improve properties of the base composition, such as improved absorbance of water of components of the base composition. The cooling 16 to a temperature below 85° C., lends the heat treated base composition a temperature suitable for further processing and minimizes risks which may be associated with prolonged heat treatment, such as negative effects on taste or nutritional values.

The homogenization 18 may be followed by cooling 20 below 15° C., or within the range of 15 to 0° C., such as 15 to 5° C., for example around 11° C., or around 6° C.

The homogenization 18 may, for example, be conducted at 200/50 bar pressure. The homogenization 18 may be conducted for example, using a two-stage homogeniser. It shall be realised that other suitable type of homogenization 18 may be used, such as a one-stage homogenizer. Other pressures than the 200/50 bar may be used.

The vegetable fat may be subjected to melting by heating prior to being provided for the base composition.

Thereby, the vegetable fat may more efficiently be mixed in with other ingredients of the base composition. Further, solid, or semi-solid fats may be used with the method.

The method 10 may further comprise: mixing the base composition, following the providing 12 the base composition, and preceding the subjecting the composition to heat treatment.

The mixing the base composition may initiate emulsification and/or homogenistation of the base composition. Further, components of the base composition, such as any proteins present, such as oat proteins from the oat derived material, may be allowed to hydrate, thus may provide improved emulsification and homogenisation.

The mixing the base composition may be associated with, or additionally comprise, a holding time prior to the subjecting the base composition to heat treatment 14.

According to the fifth aspect there is provided a non-dairy frozen dessert comprising the composition according to any one of the first aspect and the second aspect. Examples of frozen desserts, more precisely soft serve and milk shake analogue type of frozen desserts will now be presented and discussed.

### Example 1—Non-Dairy Soft Serve Composition

Non-dairy soft serve composition was manufactured according to the method for producing a non-dairy frozen dessert composition according to the third aspect. Two examples of different recipes used for the soft serve composition will be described below. Additional recipes have been tested, both within and outside present aspects, from which the below recipes have been selected as providing desirable properties, for example concerning taste, creaminess and levels of sugar and fat.

For those examples, the oat-derived material was in form of a deamidated liquid oat base, which was readily available for the experiments. The liquid oat base for the examples may be obtained from treatment of oats comprising treatment with amylase, and using protein deamidase for providing deamidated oat proteins. The liquid oat base had a dry matter of 14% by weight of the liquid oat base, and was mixed with other ingredients of the soft serve composition. Three different recipes are presented here, recipes I, II, and III as listed in tables 1-3, respectively. The total weight of each of the batches was 25 kg. The compositions were mixed and homogenized until a homogenous mixture was achieved. A two-stage homogenizer was used with a pressure of 200/50 bar, but it shall be realised that other other suitable means of homogenisation may be used. The homogenised compositions indicate good long term stability. At least several days have been verified.

TABLE 1
Recipe I:

| | Amounts |
|---|---|
| | (by weight of |
| Ingredient | composition) |
| Oat base³, deamidated (14% dry matter) | 25.00% |
| Water | 46.15% |
| Sugar (Sucrose) | 7.00% |
| Glucose syrup¹ | 9.50% |
| Maltodextrin | 4.00% |
| Coconut oil (non-hydrogenated) | 2.50% |
| Dextros | 4.00% |
| Emulsifier and stabilizer Blend with starch² | 1.75% |
| Salt | 0.05% |
| Flavouring | 0.05% |
| Total | 100.00% |

TABLE 2
Recipe II:

| | Amounts |
|---|---|
| | (by weight of |
| Ingredient | composition) |
| Oat base³, deamidated (14% dry matter) | 25.00% |
| Water | 46.15% |
| Sugar (Sucrose) | 6.00% |
| Glucose syrup¹ | 6.00% |
| Maltodextrin | 6.50% |
| Coconut oil (non-hydrogenated) | 3.00% |
| Dextros | 2.00% |
| Emulsifier and stabilizer Blend with starch² | 1.75% |
| Salt | 0.05% |
| Flavouring | 0.05% |
| Fructose | 3.50% |
| Total | 100.00% |

TABLE 3
Recipe III:

| | Amounts |
|---|---|
| | (by weight of |
| Ingredient | composition) |
| Oat base³, deamidated (14% dry matter) | 25.00% |
| Water | 45.65% |
| Sugar (Sucrose) | 6.00% |
| Glucose syrup¹ | 6.00% |
| Maltodextrin | 6.50% |
| Coconut oil (non-hydrogenated) | 3.5% |
| Dextros | 2.00% |
| Emulsifier and stabilizer Blend with starch² | 1.75% |
| Salt | 0.05% |
| Flavouring | 0.05% |
| Fructose | 3.50% |
| Total | 100.00% |

Below notes 1-3 refer to tables 1-3:

¹Note: The glucose syrup comprises 75%-85%, or about 80%, by weight of dry solids. The glucose syrup comprises about 25-35%, or about 29%, by weight of sugars. Thus, the sugar provided with the glucose syrup is about 1.3-2.1%, or about 1.5-2.0%, or about 1.7%, by weight of the soft serve composition for recipes II and III, and about 2-3.5%, or about 2.5-3.0, or about 2.8%, by weight of the soft serve composition for recipe I. The level of sugar from the oat base is about 1% by weight of the composition. The content of sugar of tables 1-3, including sugars from the glycose syrup, the sucrose, the dextrose, the fructose (where relevant) and the oat base, thus, may be about 14-15% for recipes I, II, and III. The sugar of the oat base is sugar, primarily maltose, obtained from degradation of starch from oats.

²Note: The emulsifier and stabiliser blend comprises corn starch, mono- and di glycerides of fatty acids, guar gum, and gellan gum. Of the emulsifier and stabiliser blend, 0.75%, by weight of the soft serve composition consisted of mono- and di glycerides of fatty acids, guar gum, and gellan gum, and the emulsifier and stabiliser blend was further mixed with 1%, by weight of the soft serve composition, of corn starch.

³Note: The deamidated oat base was an aqueous liquid oat base having a dry matter of 14%, derived from oats, the remaining 86% being water. The total amount of water in the soft serve composition of the recipes I and II, thus, has a water content of about 67-68% from added water and added via the oat base. Some additional water may be introduced to the compositions via other ingredients. The level of total water in the compositions may therefore be about 67-70%. Further, the 14% dry matter of the oat-derived material, of the liquid oat base provides about 3.5% dry matter by weight of the soft serve composition.

Different compositions of the oat derived material have been used. The liquid oat base of tables 1-3, comprised the following expressed in % by weight of the liquid oat base: sugars 4-6%, or 5%; beta glucans 0.25-0.75%, or 0.5%; fat 0.5-1%, or 0.8%; and proteins 1-2%, or 1.5%. Carbohydrates, including the sugars, was present at 7-10.5%, or 9.5%. Thus, within the following intervals, expressed as % by dry weight of the liquid oat base, sugars 30-40%; beta glucans 2-6%; fat 4-8%; and proteins 9-13%. Carbohydrates, including the sugars, was present at 65-80%.

It can be concluded that the non-dairy soft serve composition of the example has ingredients within the first aspect and, further, within ranges which may be expressed as follows: Oat-derived material, such as liquid aqueous oat base, comprising dry matter in an amount of 2.5-4.5%, or 3-4%, such as 3.5%, by weight of the soft serve composition; the vegetable fat (not including fat from the oat base) is present in an amount of 2-4%, or 3-4%, such as 3.5% or 3%, by weight of the soft serve composition; the sugars (not including sugars from the oat base) are present in an amount of 10-16%, or 12.7-13.7%, for example 13%, by weight of the soft serve composition, and comprises sucrose, sugar from glucose syrup, and dextrose, and optionally, for recipe II and III, fructose; the maltodextrin is present in an amount of 3 to 8%, such as 3 to 5% or 5.5 to 7.5%, for example 4% or 6.5%, by weight of the soft serve composition; mono- and di-glycerides of fatty acids, guar gum, and gellan gum of the emulsifier and stabiliser blend are present in an amount of 0.25 to 1.25%, or 0.8%, by weight of the soft serve composition; and the water is present in an amount of 65 to 73%, or 69 to 70%, by weight of the soft serve composition.

Starch mixed with mono- and di glycerides of fatty acids, guar gum, and gellan gum of the emulsifier and stabiliser blend was available and used for the experiment. Emulsifier and stabilizer blends without the starch was also used in experiments with desirable results. It was, however, found from comparing experiments that soft serves made without a content of starch present with the emulsifier and stabilizer blend may be perceived as icier, or containing ice crystals, which may be perceived by a consumer as less pleasant, as compared with starch present with the emulsifier and stabilizer blend.

The emulsifier and stabiliser blend used in example 1, may be described as an emulsifier and stabiliser blend present in an amount of 0.25-1.25%, or 0.5-1%, or more precisely about 0.8% by weight of the soft serve composition comprising at least 90% by weight, or 95-100% by weight, or 100% by weight, of mono- and di-glycerides of fatty acids, guar gum, and gellan gum. For this example, the emulsifier and stabiliser blend being was mixed with starch (1% by weight of the soft serve composition).

It has been unexpectedly found from experiments, including recipes I, II, III discussed here, that non-dairy soft serves can be made with a soft serve machine and have been found to provide in particular suitable properties in terms of stability, taste, and organoleptic properties, and with low levels of fat and sugar. It is a challenge to provide a non-dairy soft serve having those properties, and further with no or low levels of proteins. The deamidated oat base showed to improve emulsification stability, and was used in example 1, although it is, alternatively, possible to provide soft serves using oat base which has not undergone deamidation. The use of maltodextrin, used according to recipes I-III, was shown to be in particular suitable together within the levels of fat of the first aspect, and example 1, and in particular with the coconut oil. Thereby a non-dairy soft serve with a low level of fat may be provided. The levels of maltodextrine is believed to provide eg. creaminess and body even with low fat, thus acting in replacement of fat of the soft serve. Further, the maltodextrine is belied to improve other sensory sensations, assists in water binding and stabilize firmness. The levels of maltodextrine used within aspects, and of the examples were found to provide smaller and preferred ice crystals of the frozen desserts. It is believed that the oat material may contribute to improved (reduced) sensation of the ice crystals/improved crystallisation.

Recipes I, II, and III were selected out of a plurality of recipes as they were found to be particularly suitable. It shall be noted that recipes II and III has a higher level of maltodextrin, as compared to recipe I, which was found to work well together with the somewhat lower levels of sugar, as compared to recipe I. The type and level of different sugars differ somewhat between the recipes, although the total amount of sugar is similar but also somewhat different. The different type and amount of sugars in the recipes I, II and III were found to provide similar and desirable creaminess, sweetness and taste to the soft serves. It is believed that the desirable properties of recipes I-III, even though type and levels of different sugars, level of fat and maltodextrin differ, may be contributed to the specific ranges of levels as specified for the compositions of the aspects and in combination with the specific ranges of water present, or the level of dry matter, in the compositions. It is also believed that a content of fructose in combination with reduced levels of other sugars, such that the total level of sugars is decreased, combined with increase of maltodextrin, desirable properties of the soft serve, including eg. sweetness and creaminess, is achievable at lower total sugar levels.

Such levels of sugars, maltodextrin are exemplified in recipes I, II, and III, of which only recipe II contains fructose, combined with lower levels of glycose syrup, dextrose, and sucrose, but combined with higher level of maltodextrin and fat.

With similarities to example I, a soft serve composition may be described, expressed in % by weight of the soft serve composition, by comprising an oat-derived material, such as liquid aqueous oat base, comprising dry matter in an amount of 3-4%, or 3.5%; vegetable fat (not including fat from the oat base), which may be coconut oil, present in an amount of 2-4%, such as 3.5%; sugars (not including sugars from the oat base) present in an amount of 12-14%, or 12.7-13.7%, and comprising sucrose, sugar from glucose syrup, and dextrose; maltodextrin present in an amount of 3 to 8%, or 3-5% or 5.5-7.5%, or 4 or 6.5%%; mono- and di-glycerides of fatty acids, guar gum, and gellan gum of the emulsifier and stabiliser blend present in an amount of 0.5 to 1%, or about 0.8%; optionally combined with 0.5-1.5, or 1% of starch, and water present in an amount of 67-70%.

Further, a soft serve composition may be described, expressed in % by weight of the soft serve composition, by comprising an oat-derived material, such as liquid aqueous oat base, comprising dry matter in an amount of 3-4%, or 3.5%; vegetable fat (not including fat from the oat base), which may be coconut oil, present in an amount of 2-4%, such as 3%; sugars (not including sugars from the oat base) present in an amount of 12.5-14.5%, or 13-14%, and comprising sucrose, sugar from glucose syrup, dextrose, and fructose; maltodextrin present in an amount of 5.5-7.5%, 6-7%, or 6.5%; mono- and di-glycerides of fatty acids, guar gum, and gellan gum of the emulsifier and stabiliser blend present in an amount of 0.5 to 1%, or about 0.8%; optionally combined with 0.5-1.5, or 1% of starch, and water present in an amount of 67-71%.

Optionally, the compositions may comprise flavourings and/or salt. Flavorings may be selected from the list consisting of vanilla, chocolate (cocoa), caramel, strawberry, raspberry, blueberry, and combinations thereof. The flavourings and/or salt may be present in the composition in amounts up to 1%, or up to 0.5%, by weight of the composition.

The oat-derived material seems to provide sensory benefits, and, for example, adds to complexity of taste, while at the same time allowing stable emulsions, also over time.

### Example 2—Production of a Non-Dairy Soft Serve from the Non-Dairy Soft Serve Composition

A commercially available soft serve machine was used together with the soft serve compositions as described under example 1. The non-dairy soft serve compositions were added to the machine separately. Air was mixed into the soft serve compositions, and the soft serve compositions were frozen within the machine. Soft serves were extracted from the machine. The soft serve compositions were consumed and found desirable. The overrun was above 45%. No undesirable crystal growth was perceived with the recipes I-III.

### Example 3—Non-Dairy Milkshake Analogue Composition

Non-dairy milkshake analogue composition was manufactured according to the method for producing a non-dairy frozen dessert composition according to the third aspect. Four examples of different recipes were used for the milkshake analogue composition as will be described below (recipes IV-VI). Additional recipes have been tested, both within and outside present aspects, from which the below recipes have been selected as providing desirable properties, for example concerning taste, creaminess and levels of sugar and fat.

For those examples, the oat-derived material was in form of a deamidated liquid oat base, which was readily available for the experiments. The liquid oat base for the examples may be obtained from treatment of oats comprising treatment with amylase, and using protein deamidase for providing deamidated oat proteins. The liquid oat base had a dry matter of 14% by weight of the liquid oat base, and was mixed with other ingredients of the milkshake analogue composition. Three different recipes were used as listed in tables 4-6, respectively. The total weight of each of the batches was 25 kg. The compositions were mixed and homogenized until a homogenous mixture was achieved. A two-stage homogenizer was used with a pressure of 200/50 bar, but it shall be realised that other suitable means of homogenization may be used. The homogenised compositions indicate good long term stability. At least several days have been verified.

TABLE 4
Recipe IV

| | Amounts |
|---|---|
| | (by weight of |
| Ingredient | composition) |
| Oat base³, deamidated (14% dry matter) | 20.0% |
| Water | 55.25% |
| Sugar (Sucrose) | 10.0% |
| Glucose syrup¹ | 4.0% |
| Maltodextrin | 5.0% |
| Coconut oil | 1.9% |
| Dextros Meritose 200 | 2.0% |
| Emulsifier and stabilizer Blend with starch² | 1.75% |
| Salt | 0.05% |
| Flavouring | 0.05% |
| Total | 100% |

TABLE 5
Recipe V

| | Amounts |
|---|---|
| | (by weight of |
| Ingredient | composition) |
| Oat base³, deamidated (14% dry matter) | 20.0% |
| Water | 55.3% |
| Sugar (Sucrose) | 7.0% |
| Glucose syrup¹ | 4.5% |
| Maltodextrin | 4.9% |
| Coconut oil | 2.0% |
| Dextros | 1.5% |
| Fructose | 3.0% |
| Emulsifier and stabilizer Blend with starch² | 1.75% |
| Salt | 0.04% |
| Flavouring | 0.04% |
| Total | 100% |

TABLE 6
Recipe VI

| | Amounts |
|---|---|
| | (by weight of |
| Ingredient | composition) |
| Oat base³, deamidated (14% dry matter) | 20.0% |
| Water | 54.08% |
| Sugar (Sucrose) | 9.85% |
| Glucose syrup¹ | 4% |
| Maltodextrin | 7% |
| Coconut oil | 1.98% |
| Dextros | 2% |
| Fructose | 0% |
| Emulsifier and stabilizer Blend with starch² | 1% |
| Salt | 0.04% |
| Flavouring | 0.04% |
| Total | 100% |

Below notes 1-3 refer to tables 4-6:

¹Note: The glucose syrup comprises 75%-85%, or about 80%, by weight of dry solids. The glucose syrup comprises about 25-35%, or about 29%, by weight of sugars. Thus, the sugar provided with the glucose syrup is about 1-1.5%, or about 1.2%, by weight of the milkshake analogue composition. The level of sugar from the oat base is about 1% by weight of the composition. The content of sugar of table 1, including sugars from the glycose syrup, the sucrose, the dextrose, and the oat base, thus, may be about 14% for recipes III-VI. The sugar of the oat base is sugar obtained from degradation of starch from oats, primarily maltose.

²Note: The emulsifier and stabiliser blend comprises corn starch, mono- and di glycerides of fatty acids, guar gum, and gellan gum. Of the emulsifier and stabiliser blend, 0.75%, by weight of the milkshake analogue composition according to recipes IV and V consisted of mono- and di glycerides of fatty acids, guar gum, and gellan gum, and the emulsifier and stabiliser blend was further mixed with 1%, by weight of the milkshake analogue composition, of corn starch. Of the emulsifier and stabiliser blend, 0.42%, by weight of the milkshake analogue composition according to recipe VI, consisted of mono- and di glycerides of fatty acids, guar gum, and gellan gum, and the emulsifier and stabiliser blend was further mixed with 0.58%, by weight of the milkshake analogue composition, of corn starch.

³Note: The deamidated oat base was an aqueous liquid oat base having a dry matter of 14%, derived from oats, the remaining 86% being water. The total amount of water in the milkshake analogue composition of the recipes IV and V, thus, has a water content of about 72% from added water and added via the oat base. The total amount of water in the milkshake analogue composition of the recipe VI, thus, has a water content of about 71% from added water and added via the oat base. Some additional water may be introduced to the compositions via other ingredients. The level of total water in the compositions may therefore be about 71-75%. Further, the 14% dry matter of the oat-derived material, of the liquid oat base provides about 2.8% dry matter by weight of the milkshake analogue composition.

It can be concluded that the non-dairy milkshake analogue composition of the example has ingredients within the first aspect and, further, within the following ranges, by weight of the soft serve composition: Oat-derived material, such as liquid aqueous oat base, comprising dry matter in an amount of 2-4%, or 2.5-3%, such as 2.8%; the vegetable fat (not including fat from the oat base) is present in an amount of 1 to 3%, or 1.5 to 2.5, such as 1.9% or 2%; the sugars (not including sugars from the oat base) are present in an amount of 11-15%, 12-14%, or about 13%, and comprises sucrose, sugar from glucose syrup, and dextrose, and optionally, for recipes V and VI, fructose; the maltodextrin is present in an amount of 4-9%, such as 6-8, or around 5% or around 7%; mono- and di-glycerides of fatty acids, guar gum, and gellan gum of the emulsifier and stabiliser blend are present in an amount of 0.25 to 1.25%, or about 0.4% or 0.8%, by weight of the soft serve composition; and the water is present in an amount of 71-75%, by weight of the soft serve composition.

Optionally, the compositions may comprise flavourings and/or salt. Flavorings may be selected from the list consisting of vanilla, chocolate (cocoa), caramel, strawberry, raspberry, blueberry, and combinations thereof. The flavourings and/or salt may be present in the composition in amounts up to 1%, or up to 0.5%, by weight of the composition.

The used amounts of maltodextrin, in combination with the other ingredients, provided suitable sizes of ice crystals.

Notably, with the compositions described herein, it is not necessary to add proteins in addition to any proteins provided with the oat-derived material. Surprisingly, for example, desirable creaminess and stability were achieved without additional proteins.

The levels of fat and sugar are desirably low in the recipes I-VI. As a means of comparing the levels of fat and sugar of present recipes and aspects, fat and sugar contents of commercially available soft serves are presented below in table 7.

TABLE 7
Comparing examples of commercially available soft serves
(sample Nos. 1-6) and milkshake analogue (sample No. 7):

| Sample | Sugar | Fat | |
|---|---|---|---|
| No. | (% by weight) | (% by weight) | Comment |
| 1. | 20 | 3.5 | Dairy product |
| 2. | 19.5 | 3.8 | Dairy product |
| 3. | 25 | 7.5 | Dairy product |
| 4. | 13 | 5.5 | Dairy product |
| 5. | 16 | 7.3 | Dairy product |
| 6. | 17 | 7.9 | Non-dairy product |
| 7. | 52 | 13 | Non-dairy product |

All of the comparing samples have a fat content higher than the recipes I-VI of the present disclosure. All of the comparing examples, except No. 4, have a sugar content considerably higher than recipes I-VI. No. 4 may have a sugar content similar to recipes I-VI, but a considerably higher fat level.

In spite of the relatively low levels of sugar and fat of present recipes I-VI, they have been described as rich and creamy.

1. A non-dairy frozen dessert composition, the composition comprising:
an oat-derived material comprising dry matter in an amount of 1 to 7% by weight of the frozen dessert composition;
vegetable fat present in an amount of 1 to 5% by weight of the frozen dessert composition
sugars present in an amount of 5 to 20% by weight of the frozen dessert composition,
maltodextrin present in an amount of 3 to 8% by weight of the frozen dessert composition,
emulsifier and stabilizer blend, and
water.

2. The non-dairy frozen dessert composition according to claim 1, wherein the frozen dessert composition is a soft serve composition, wherein
the oat-derived material comprises dry matter in an amount of 2.5 to 5% by weight of the frozen dessert composition, and
the water is present in an amount of 62 to 75% by weight of the frozen dessert composition.

3. The non-dairy frozen dessert composition according to claim 1, wherein the frozen dessert composition is a milkshake analogue composition, wherein,
the oat-derived material comprises dry matter in an amount of 1.5 to 3.5% by weight of the frozen dessert composition, and
the water is present in an amount of 68 to 80% by weight of the frozen dessert composition.

4. The non-dairy frozen dessert composition according to claim 1, wherein the sugars comprise one or more of sucrose, dextrose, fructose, sugars from dried glucose and sugars from glucose syrup.

5. The non-dairy frozen dessert composition according to claim 1,
wherein the emulsifier and stabilizer blend comprises one or more compounds selected from the group consisting of mono- and di-glycerides of fatty acids, guar gum, and gellan gum, in a total amount of 0.25-2% by weight of the frozen dessert composition.

6. The non-dairy frozen dessert composition according to claim 1, wherein the vegetable fat comprises coconut fat or non-hydrogenated coconut fat.

7. The non-dairy frozen dessert composition according to claim 1, wherein the oat-derived material has been obtained from treatment of oats comprising degradation of starch.

8. The non-dairy frozen dessert composition according to claim 1, wherein the oat-derived material is a liquid oat base or an oat drink, or a combination thereof.

9. The non-dairy frozen dessert composition according to claim 1, wherein the oat-derived material is a deamidated oat-derived material.

10. The non-dairy frozen dessert composition according to claim 1, wherein the oat-derived material comprises one or more of monosaccharides, disaccharides, for example maltose, oligosaccharides, and fibers, including β-glucan.

11. The non-dairy frozen dessert composition according to claim 1, wherein
the oat-derived material comprises dry matter in an amount of 2.5 to 4.5% by weight of the frozen dessert composition,
the vegetable fat is present in an amount of 2 to 4% by weight of the frozen dessert composition
the sugars are present in an amount of 11 to 16% by weight of the frozen dessert composition, and comprises sucrose, and sugar from one or both of glucose syrup or dried glucose, and one or more of dextrose and fructose
the maltodextrin is present in an amount of 3 to 8% by weight of the frozen dessert composition,
the emulsifier and stabilizer blend is present in an amount of 0.25 to 1.25% by weight of the frozen dessert composition, and
the water is present in an amount of 65 to 73% by weight of the frozen dessert composition.

12. The non-dairy frozen dessert composition according to claim 1, wherein
the oat-derived material comprises dry matter in an amount of 3-4% by weight of the frozen dessert composition;
the vegetable fat is present in an amount of 3-4%% by weight of the frozen dessert composition;
the sugars are present in an amount of 12.7-13.7% by weight of the frozen dessert composition;
the maltodextrin is present in an amount of 3 to 8% by weight of the frozen dessert composition;
the emulsifier and stabilizer blend is present in an amount of 0.5 to 1% by weight of the frozen dessert composition; and
the water is present in an amount of 67-70% by weight of the frozen dessert composition.

13. The non-dairy frozen dessert composition according to claim 1, wherein
the oat-derived material comprises dry matter in an amount of 1.5 to 3.5% by weight of the frozen dessert composition,
the vegetable fat is present in an amount of 1 to 3% by weight of the frozen dessert composition,
the sugars are present in an amount of 11 to 15% by weight of the frozen dessert composition, and comprises sucrose and sugar from glucose syrup or dried glucose, dextrose, and, optionally, fructose
the maltodextrin is present in an amount of 4 to 9% by weight of the frozen dessert composition,
the emulsifier and stabilizer blend is present in an amount of 0.25 to 1.25% by weight of the frozen dessert composition, and
the water is present in an amount of 69 to 78% by weight of the frozen dessert composition.

14. The non-dairy frozen dessert composition according to claim 1, wherein
the oat-derived material comprises dry matter in an amount of 2.3 to 3.3% by weight of the frozen dessert composition,
the vegetable fat is present in an amount of 1.5 to 2.5% by weight of the frozen dessert composition,
the sugars are present in an amount of 12 to 14% by weight of the frozen dessert composition, and comprises sucrose and sugar from glucose syrup or dried glucose, dextrose, and, optionally, fructose
the maltodextrin is present in an amount of 6 to 8% by weight of the frozen dessert composition,
the emulsifier and stabilizer blend is present in an amount of 0.25 to 1.25% by weight of the frozen dessert composition, and
the water is present in an amount of 71 to 75% by weight of the frozen dessert composition.

15. A non-dairy frozen dessert composition, the composition comprising:
an oat-derived material comprising dry matter in an amount of 6 to 16% by dry weight of the composition,
vegetable fat present in an amount of 5-15% by dry weight of the composition,
sugars present in an amount of 25-45% by dry weight of the composition,
maltodextrin present in an amount of 5 to 25% by dry weight of the composition, and
emulsifier and stabilizer blend.

16. A method for producing a non-dairy frozen dessert from a non-dairy frozen dessert composition, the method comprising:
providing the non-dairy frozen dessert composition according to claim 1,
mixing in air, and
freezing the non-dairy frozen dessert composition.

17. The method according to claim 16, wherein the method for producing a non-dairy frozen dessert from the non-dairy frozen dessert composition is performed using a soft serve apparatus or a milkshake apparatus.

18. A method, for manufacturing of a non-dairy frozen dessert composition according to claim 1, the method comprising:
providing a base composition comprising:
an oat-derived material, vegetable fat, sugars, maltodextrin, emulsifier and stabilizer blend, and water;
subjecting the base composition to heat treatment at a temperature above 125° C. followed by cooling to a temperature below 85° C.;
subjecting the base composition to homogenization followed by cooling below 30° C., thereby obtaining the non-dairy frozen dessert composition.

19. The method according to claim 18, wherein the vegetable fat is subjected to melting by heating prior to being provided for the base composition.

20. The method according to claim 18, further comprising mixing the base composition, following the providing the base composition, and preceding the subjecting the composition to heat treatment.

21. A non-dairy frozen dessert comprising the composition according to claim 1.
